(19) United States
(12) Patent Application Publication
(10) Pub. No.: US 2013/0084371 A1
(43) Pub. Date: Apr. 4, 2013

(54) Silver and Germanium Electrodes In Ohmic And PEF Heating

(71) Applicant: PepsiCo, Inc., Purchase, NY (US)

(72) Inventors: John Andrew Eaton, Oxford, CT (US); Youssef El-Shoubary, North Brunswick, NJ (US); Herriot Moise, Putnam, NY (US); Cynthia M. Stewart, Carmel, NY (US)

(73) Assignee: PepsiCo, Inc., Purchase, NY (US)

(21) Appl. No.: 13/625,935

(22) Filed: Sep. 25, 2012

Related U.S. Application Data
(60) Provisional application No. 61/541,115, filed on Sep. 30, 2011.

(51) Int. Cl. A23L 3/005

(52) U.S. Cl. CPC A23L 3/005
USPC 426/244

(57) ABSTRACT

A method of heating a liquid comprises heating the liquid with an ohmic or PEF heater comprising at least one silver or silver alloy electrode or germanium or germanium alloy electrode. Silver or germanium ions are leached from the at least one silver electrode in an amount to provide the antimicrobial effect in the liquid. The liquid may contain particulates. The electrodes provide product stability and longer shelf life.

### CROSS-REFERENCE TO RELATED APPLICATIONS

This application claims priority to U.S. Ser. No. 61/541,115 filed Sep. 30, 2012, hereby incorporated by reference in its entirety.

### FIELD OF THE INVENTION

The invention relates to the use of silver and/or germanium electrodes in ohmic heating or pulsed electric field (PEF) heating of liquid foods.

### BACKGROUND OF THE INVENTION

Ohmic heating is an advanced thermal processing method wherein liquid food material, which serves as an electrical resistor, is heated by passing electricity through the food material. Electrical energy is dissipated into heat, which results in rapid and uniform heating. Ohmic heating is also called electrical resistance heating, Joule heating, or electro-heating, and may be used for a variety of applications in the food industry. High intensity pulsed electric field (PEF) processing involves the application of pulses of high voltage (typically 20-80 kV/cm) to foods placed between 2 electrodes. Typically the electrodes used in ohmic or PEF heating are titanium, stainless steel, or corrosion resistant hastelloy.

Both ohmic and PEF heating use electrodes and electric current. However, PEF treatment is conducted at ambient, sub-ambient, or slightly above ambient temperature for less than 1 second, minimizing energy loss due to heating of foods. Ohmic heating applies heat continuously to heat up the food matrix.

For food products and beverages that contain large particulates (for example in soup products), the use of conventional heat-transfer techniques frequently necessitates over-processing of the liquid phase to ensure that the center of each particulate is sterilized. This can result in destruction of flavors and nutrients and compromise the organoleptic properties of the particulate. Ohmic heating (as well as PEF heating) allows for faster and more uniform heating of food products which contain particulates without reducing their textural and nutritional quality. Thus, ohmic heating, compared to steam, can prevent heterogeneous heating effects that may cause hot- or cold-spots which compromise the quality and safety of the resultant food product.

An important phenomenon observed in electro heating is related to electrode synergy, heating efficiency, and leaching of the electrode material. Electrode synergy has been reported for stainless steel and titanium electrodes. Synergy is two or more things functioning together to produce a result not independently obtainable. Silver by itself or electrical heating by itself does not produce Z and D values compared to the Z and D values obtained when used together. Energy efficiency of electrodes has been reported to be 85% for titanium and stainless steel. The electrode material should be energy efficient which means the amount of energy supplied to the electro cell should be efficiently transferred to the food.

### BRIEF SUMMARY OF THE INVENTION

It was discovered that the use of silver electrodes during ohmic or PEF heating provides unexpected benefits compared to the use of other electrode materials. The silver provides an anti-microbial effect that unexpectedly reduces the sterilization time and/or heating temperature. That is, silver electrodes provide a heating efficiency much greater than other electrodes. Further the death curve of microorganisms accelerated using silver electrodes (lower Z & D values.)

It was further discovered that other electrodes may provide such anti-microbial effects such as germanium electrodes.

One aspect of the invention is directed to a method of heating a liquid comprising heating the liquid with an ohmic heater comprising at least one silver, silver alloy, germanium, or germanium alloy electrode.

Another aspect of the invention is directed to a method of heating a liquid comprising the liquid with a Pulse Electric Field (PEF) heater comprising at least one silver, silver alloy, germanium, or germanium alloy electrode. Such heating is effective to treat, sterilize, and/or pasteurize the liquid.

Another aspect is directed to the heating of a liquid containing particulates by ohmic heating or PEF heating.

Another aspect of the invention is the heating of a liquid which is a viscous or pumpable fluid.

### BRIEF DESCRIPTION OF THE DRAWINGS

FIG. 1 depicts a schematic diagram of an ohmic heater.

FIG. 2 depicts geometry of electrodes useful in ohmic heating.

FIG. 3 depicts position of thermocouples in an ohmic cell.

FIG. 4 depicts come-up times for silver electrodes.

FIG. 5 depicts come-up times for titanium electrodes.

FIG. 6 depicts come-up times for stainless steel electrodes.

FIG. 7 depicts time-related increase of come-up times for titanium electrodes.

FIG. 8 depicts come-up times for silver, stainless steel, and titanium electrodes at 125 volts.

FIG. 9 depicts energy efficiency using stainless steel, titanium, and silver electrodes.

FIG. 10 depicts a summary of total bacterial count for samples prepared using silver electrodes in comparison with samples prepared using titanium electrodes.

FIG. 11 depicts temperature profiles obtained under different voltages for silver electrodes.

FIG. 12 depicts the effect of different frequencies and frequency type on the heating rate using V=110v and silver electrodes.

FIG. 13 depicts the heating profile for one size pineapple in pineapple juice using silver electrodes.

FIG. 14 depicts the heating profile for another size pineapple in pineapple juice using silver electrodes.

FIG. 15 depicts the effect of conductivity on silver leaching using 125V.

FIG. 16 depicts the effect of conductivity on silver leaching using 175V.

FIG. 17 depicts the effect of pH on silver leaching.

FIG. 18 depicts the effect of voltage on silver leaching.

FIG. 19 depicts mineral concentrations measured in samples.

### DETAILED DESCRIPTION OF THE INVENTION

### Electrode Choice

Ohmic heating is a food processing operation in which heat is internally generated within foods by the passage of alternating electric current. The process enables solid particles to heat as fast as liquids, thus making it possible to use High Temperature Short Time (HTST) sterilization techniques on particulate foods. In ohmic heating, electrodes are necessary to convey the current to the food material to be heated. During heating, slight electrode corrosion occurs mainly via electro-dissolution induced by the low-frequency AC. For example, the ohmic heater utilizes low-frequency (60 Hz to 3 Kz) sinusoidal alternating current.

When an alternating current is applied to an electrolytic cell, the cell shows both dissipative and reactive characteristics. AC induced electrolysis appears closely associated with the minor corrosion of electrodes. It has been further noticed that titanium forms a passive oxide coating (also known as ‘rainbow’ titanium-oxide coating) that protects the metal from further reaction. Use of the titanium electrodes at high temperatures can accelerated the titanium oxide building process and this leads to a decrease of the heating rate.

Electrode Synergy

Thermal effect is an important part of the inactivation mechanism. For example, in one study using titanium electrodes, no difference was found between ohmic and conventional heat treatment on the death kinetics of Zygo Saccharomyces Bailli yeast cells but mild electrical pretreatment of Escherichia Coli decreased the subsequent inactivation requirement.

Recent studies suggested that mild electroporation might occur even under relatively low field strength encountered during ohmic heating, for example the presence of pore forming mechanisms in cellular tissue. A study of the kinetic of inactivation of Subtilis spores using ohmic stainless steel electrodes found that a significant improvement over conventional heating wherein D values dropped from 32.8 at 88° C. to 30.2 at the same temperature. The same conclusion was drawn at 90° C. This study provided evidence of synergy using stainless steel electrodes. The same observations were reported for thermal death kinetics of Escherichia Coli ATCC 25922 in goat milk and Bacillusllus Licheniformis ATCC 14580 spores in cloudberry jam. Significant improvement was shown with ohmic titanium electrodes over conventional heating.

The synergy improvement reported in the literature is only for titanium and stainless steel electrodes. As reflected in this application, it was discovered that the synergy effect of ohmic heating was unexpectedly magnified and enhanced when silver electrodes are used.

Silver

Antimicrobial properties of silver have been known to cultures all around the world for many centuries. The Phoenicians stored water and other liquids in silver coated bottles to discourage contamination by microbes. Silver dollars were put into milk bottles to keep milk fresh. Further, water tanks in ships and airplanes that are “silvered” are able to render water potable for months. In 1893, the antibacterial effectiveness of various metals was noted and this property was named the oligodynamic effect. It was later found that out of all the metals with antimicrobial properties, silver has the most effective antibacterial action and the least toxicity to animal cells. Silver became commonly used in medical treatments, such as those of wounded soldiers in World War I, to deter microbial growth. Silver is an approved contact surface by the FDA. Further, it was known that electrically generated silver (10 ppm or more) can be used for sterilization if added to a liquid. However, such relatively large amounts of silver cannot be used in beverages intended for consumption because it is above the drinking water standard of 0.5 ppm.

Silver Electrodes in Ohmic Heating

The present invention is directed to the use of silver or silver alloy electrodes in the ohmic heating to enhance the synergy effects of ohmic heating. Silver allow electrodes may be sterling silver or silver/germanium electrodes. The present invention leverages the antimicrobial property of the silver as well as achieves low D values.

The silver or silver alloy electrodes are stable, durable, and do not corrode. The electrodes will leach silver in amounts of 1 ppm or less, easily providing the amount of silver desired for beverages of 0.5 ppm or less. The electrodes may be used under any voltage and/or frequency.

Thus the present invention uses silver electrodes instead of, for example, the more commonly used stainless steel (where leaching of chromium might occur) and/or titanium (where energy efficiency degrades over time) and/or corrosion resistant hastelloy (where copper and nickel might leach). Leaching of silver is comparable to titanium and much better than stainless steel. It was discovered that silver electrodes have surprisingly more synergy on bacterial kill compared to titanium and stainless steel electrodes. In addition, silver electrodes provide surprisingly better energy efficiency compared to titanium and stainless steel electrodes.

Typical heating temperatures for ohmic heating can be up to 200° C. The choice of the temperature not only depends on the microorganism but also on the fluid type. The amount of heat required with common electrodes such as titanium or stainless steel is higher than the amount of heat required by silver electrodes to reach the same temperature. In other words the efficiency of silver electrode is at least 5% higher than the other electrodes. In addition with silver electrodes, it was discovered that less heat is required to achieve the same sterilization/pasteurization results (Z&D VALUES) compared to the above mentioned two electrodes. In fact, it was determined that there is a synergistic effect by the silver electrode and the heat. For example, the sterilization temperature for liquid could be decreased from a prior temperature of 135° C. to a temperature below 95° C. depending on the microorganism.

It was discovered that utilizing ohmic heating with silver electrodes as disclosed herein, electrode integrity is as good as the titanium electrode and much better than the stainless steel electrodes. A maximum of 0.5 ppm of silver loss was noticed compared to 0.3 ppm for titanium and 10 ppm for stainless steel. This translates to better electrode integrity for silver and longer use.

Therefore, the present invention is directed to the use of silver electrodes, rather than the more common electrodes in ohmic heating to enhance the synergy effects of ohmic heating by providing the antimicrobial property of the silver and achieving low D values. Silver also provides an unexpected reduction in come up time and/or sterilization temperature of the ohmic heating.

Silver Electrodes in PEF Heating

One skilled in the art, presented with the findings herein concerning ohmic heating with silver electrodes, would also expect the same or similar results for Pulse Electric field (PEF). PEF heating involves treating foods placed between electrodes by high voltage pulses in the order of 20 to 80 kV (usually for a couple of microseconds). The applied high voltage results in an electric field that causes microbial inactivation. The electric field may be applied in the form of exponentially decaying, square wave, bipolar, or oscillatory pulses and at ambient, sub-ambient, or slightly above-ambient temperature. After the treatment, the food is packaged aseptically and stored under refrigeration

High intensity pulsed electric field (PEF) processing involves the application of pulses of high voltage (typically 20-80 kV/cm) to foods placed between 2 electrodes. PEF treatment is generally conducted at ambient, sub-ambient, or slightly above ambient temperature for less than 1 s, minimizing energy loss due to heating of foods.

Germanium Electrodes

Like silver, germanium electrodes offer anti-microbial properties. Preliminary tests demonstrate that germanium electrodes will offer the same synergy effects as silver. Hence, the present application is further directed to the use of germanium and germanium alloy electrodes. For convenience, the rest of the application is discussed in terms of silver electrodes, but it is expected that germanium electrodes may be substituted for or used with silver electrodes.

Heating Liquids

The ohmic or PEF heating with silver electrode(s) may be used to heat any suitable liquid such as beverages including dairy beverages (milk products, drinkable yogurts), juices, carbonated beverage syrup, and non-carbonated beverages, such as but not limited to orange, pineapple, rape, mango, lemon ETC juices and beverage syrups. The liquid may be any pumpable fluid such as purees, high solid content fluids, pastes, syrups, and proteins such as, but not limited to, eggs, jams, and potatoes. The liquid may also be a soup such as, but not limited to, chicken, beef, and/or vegetable, as liquid broths or soup containing particulates such as meat chunks, vegetables, rice, or pasta. Other dairy products such as those containing fruits, grains, and nuts.

Particulates present in the liquid include, but are not limited to, vegetables, fruits such as berries, meats, gels, and grains such as rice, corn, or wheat including particulates prepared from grains such as noodles and cereals. The average size of the particulates typically ranges from 0.5 mm to 2 cm, in particular 0.5 mm to 10 mm. The particulates should be of a size that will allow them pass between the two electrode gaps. The particulate shape may be any suitable shape such as cubes, spheres, and strings, or may be irregular shapes.

The liquid is heated from ambient to at least 40° C. using two electrodes with and without cooling between applications of heat. For instance in ohmic heating, the liquid is generally heated up to 150° C., for instance 50° C. to 150° C. In PEF, the liquid is heated up to 50° C. to 65° C. with cooling in between applications. The residence time and effective temperature is dictated by the product type. Orange juice come up time, for example, is 2 min (voltage 110V and electrode distance=7 cm) to heat to 85° C. in ohmic heating or is heated with several pulses with PEF heating.

The liquid is heated for at least one second depending on the residence time at required temperature. The time of heating will depend on the volume of liquid being heated and other factors such as conductivity, applied voltage, distance between the electrode, and amount of particulate in the liquid, and the size of particulate.

The liquid may be stirred to distribute the heat faster. And the flow between the two electrodes should be turbulent to evenly distribute the heat and to avoid hot spots.

Both electrodes may be silver or one electrode may be silver and the other another metal such as titanium. In one aspect, one electrode is silver and the other is titanium. The size of the electrode depends on the flow rate and the residence time required achieving certain temperature. The heating could be done using several electrodes in series or in parallel to achieve required temperature and to handle required flow rates.

The current for the ohmic heating may be any suitable frequency such as low-frequency (sinusoidal, square, triangle) alternating current. Typical frequencies are 50 Hz to 3 Kz). The preferred frequency of this impounded is 50 Hz to 2 Kz for instance 60 Hz. Since this is the supplied frequency in the US and the rest of the world. Higher frequencies will require the addition of frequency control unit which could be expensive.

This process could be applied for any pumpable liquid regardless of viscosity and pH. The flow rate and the distance between the two electrodes will determine the final temperature of the fluid.

### Example 1

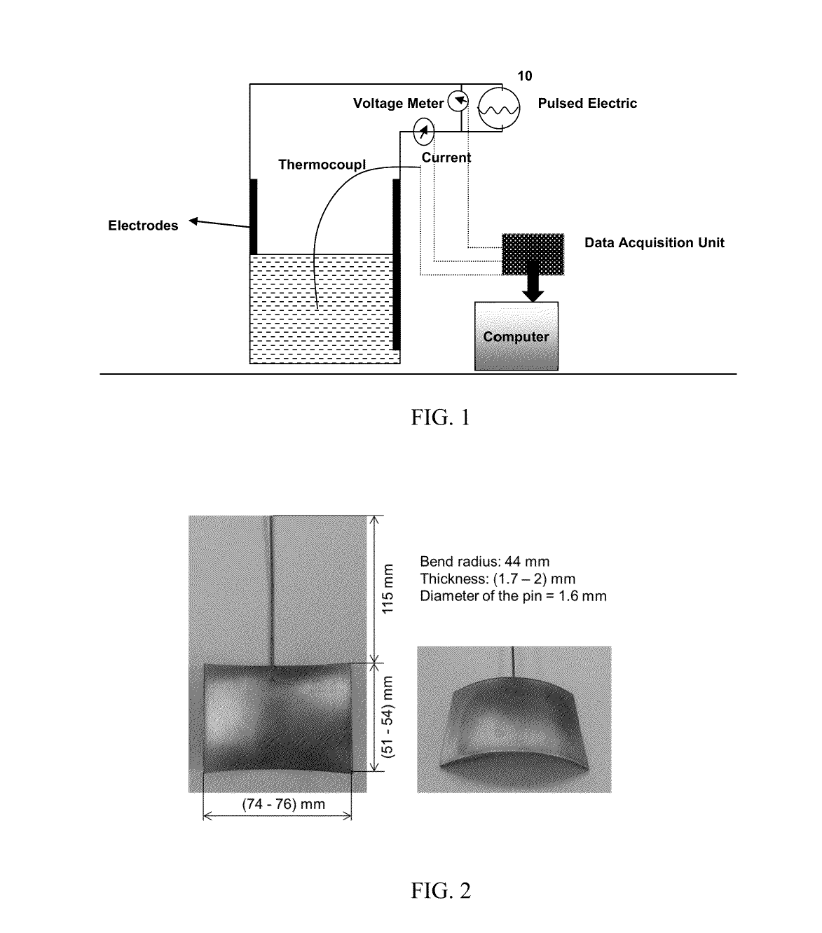

Electrochemical reactions were investigated with batch ohmic unstirred equipment as shown in FIG. 1. The following equipment and materials were used in the experiments: Ohmic cell with two electrodes (inner cell diameter 100 mm, distance between electrodes 70 mm); Power source—alternating current connected to a 60 HZ variac to adjust voltage; Temperature control unit (control box & thermocouple box); Thermocouples (Type T); Data logger (Agilent Technologies); and a computer. For pH and conductivity adjustment, the following was used: Stirring plate; Multiparameter (Oakton PCD650) with probes—to measure pH and conductivity; distilled Water; sodium sulfate (to adjust conductivity to 3 mS/cm: 2.1 g Na2SO4 per 1 liter H2O); citric acid for acidic pH adjustment; sodium chloride for caustic pH adjustment

Four different electrodes were tested: includes silver, sterling silver, titanium, stainless steel 303. FIG. 2 shows the shape of the electrodes used.

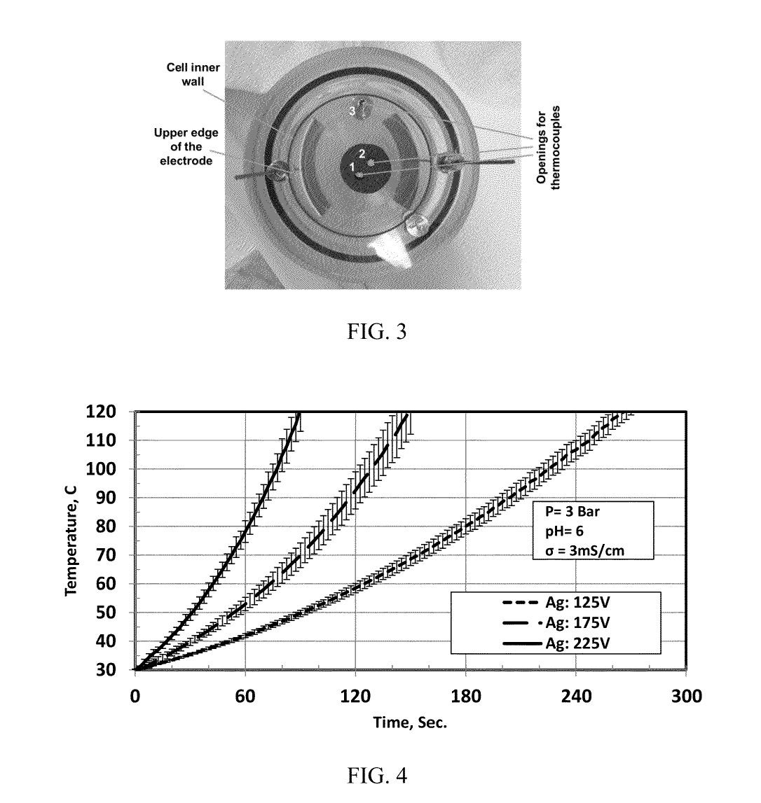

For temperature measurements three (type T) thermocouples were used. FIG. 3 shows position of the thermocouples in the ohmic cell. The three thermocouples assured that there was no temperature gradient inside the cell.

Physical properties of the test solution (electrolyte) were adjusted to required parameters. Ohmic cell was filled with 530 ml water solution, and electrodes were connected to the power source. For each set of parameters at least three replica measurements were conducted.

Effect of Material of Construction on Come Up Time

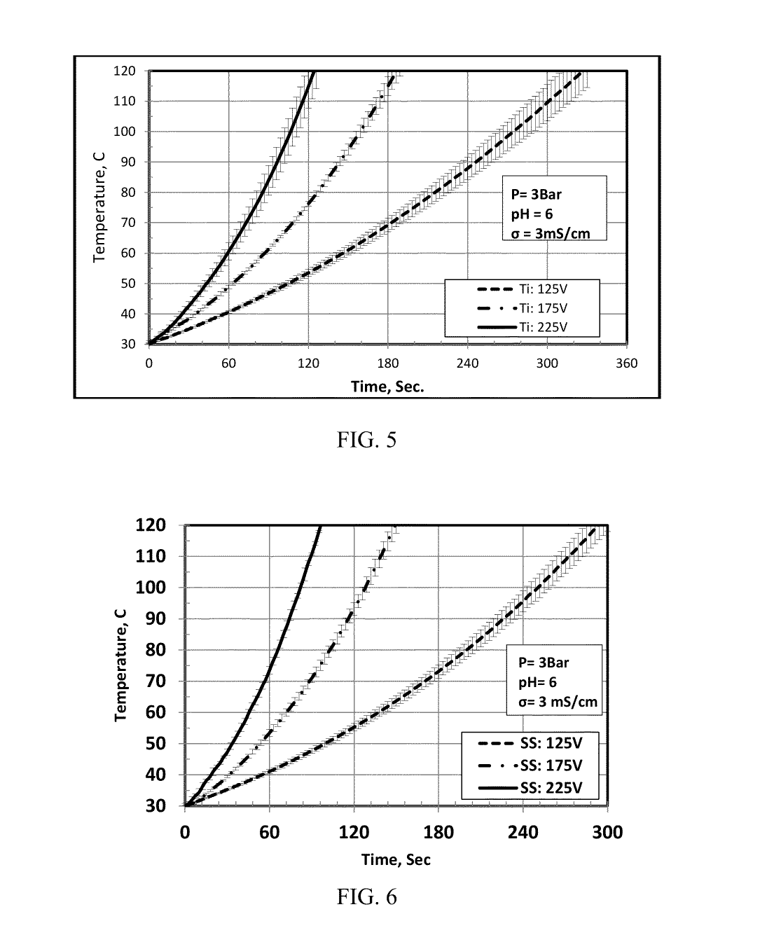

In these set of experiments the pH of water was adjusted to 6, the electrical conductivity was set to 3 mS/cm and 3 voltages were applied (125, 175 and 225V). FIGS. 4, 5, and 6 present the come-up times using ohmic heating with different electrode materials using the three above mentioned voltages individually. The curves represent average temperature values; the error bars represent the standard deviation. For all electrode materials as the applied voltage increases a significant decrease in the come-up times was noticed. For a target temperature of 95° C. increasing of the applied voltage from 125 volts to 175 volts and from 125 volts to 225 volts led to a reduction of come-up times to ˜43-49% and ˜62-69% respectively.

Effect of Continuous Usage of Titanium Electrodes on Come-Up Time

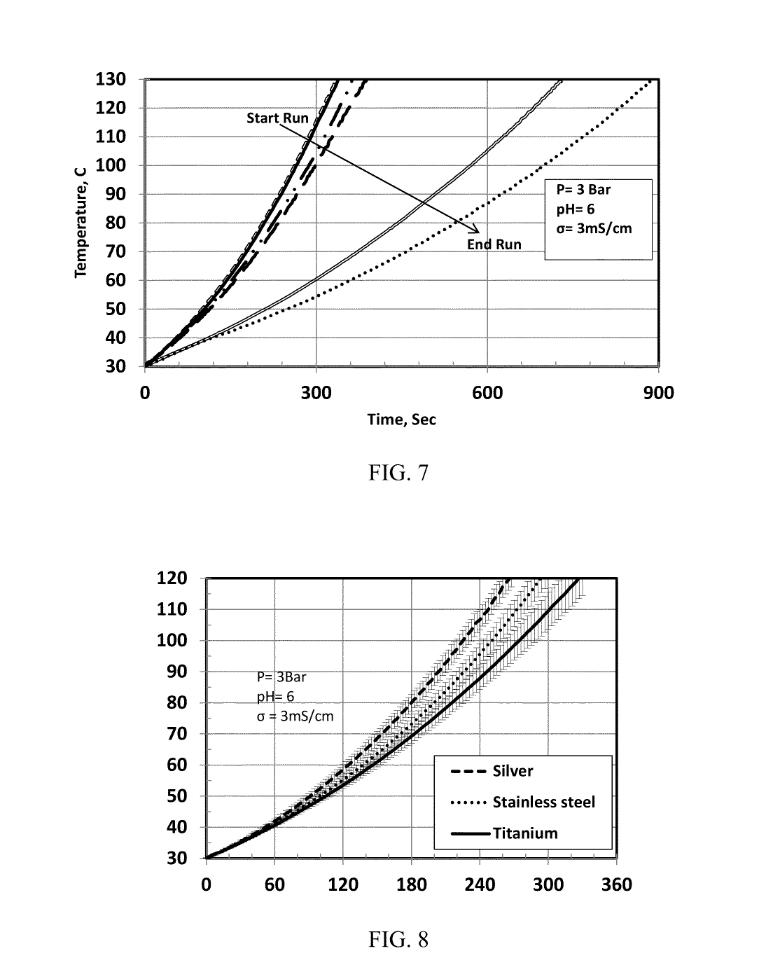

Titanium electrodes showed an increase of come-up times with increasing duration of use of the electrodes. FIG. 7 shows come-up times for titanium electrodes at 125 volts. The increase of come-up times can be explained with a property of titanium to form a passive oxide coating (also known as ‘rainbow’ titanium-oxide coating) that protects the metal from further reaction. Sanding between runs was needed to keep the electrode efficiency intake.

Electrode Material Efficiency

FIG. 8 gives a comparison between the come-up time for the three electrodes used in this study. Silver proved to be the most efficient electrode material in regard of come-up times regardless of the applied voltage. Titanium showed to be the least efficient electrode material for all applied voltages.

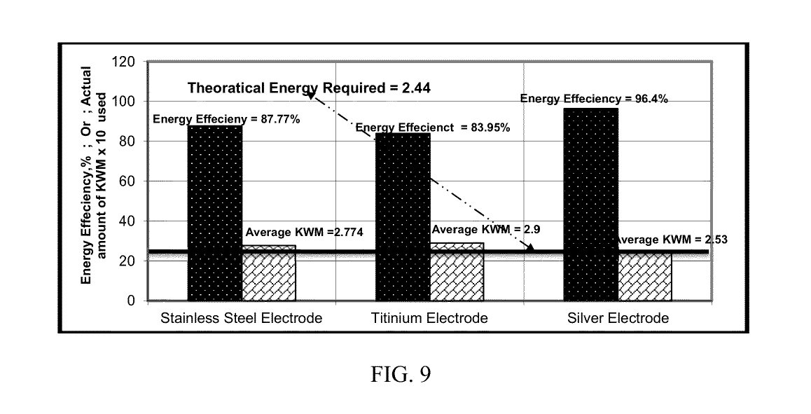

Finally, the efficiency of each pair of electrodes were calculated against the theoretical energy consumption and plotted in FIG. 9. The silver electrode efficiency is higher than both the titanium and the stainless steel Electrodes.

### Example 2

The effect of titanium and silver electrodes during ohmic heating on the D values of selected microorganisms in a model product was evaluated. The model product was chosen to be water based broth at pH 6.0 with electrical conductivity of 3 mS/cm. The same Ohmic equipment described above was used in this work.

The following strains were used in this study.

Listeria monocytogenes Scott A ATCC 49594 (FSC-CC 2473)

Salmonella Senftenberg 775 W ATCC 43845 (FSC-CC 1249)

Saccharomyces cerevisiae ATCC 9763 (FSC-CC 2764)

Neosartorya fischeri. ATCC 96179 (FSC-CC 3110)

Alicyclobacillus acidoterrestris Silliker isolate from orange juice (FSC-CC 2239)

Clostridium butyricum ATCC 19398

Microbiological Analysis: The samples (5 ml) were aseptically removed from the unit and combined with 45 ml. Butterfield's phosphate buffer. Serial dilutions (1:10 vol/vol) were analyzed by the pour plate technique (Table 1). The appearance of typical colonies was considered confirmatory.

TABLE 1

| | | Incubation Time/ |
|---|---|---|
| | | Temperature/ |
| Test | Medium | Atmosphere |
| L. monocytogenes | Trypticase soy agar with yeast | 2 d/35° C./aerobic |
| | extract with modified oxford | |
| | agar overlay | |
| S. Senftenberg | Trypticase soy agar with xylose | 2 d/35° C./aerobic |
| | lysine desoxycholate agar | |
| | overlay | |
| S. cerevisiae | Potato dextrose agar | 5 d/35° C./aerobic |
| N. fischeri | Potato dextrose agar | 5 d/35° C./aerobic |
| A. acidoterrestris | K agar | 3 d/42° C./aerobic |
| C. butyricum | Liver veal agar | 2 d/35° C./anaerobic |

Data Analysis: The base ten logarithms of the plate counts were plotted against time for each temperature and the best fit line was statistically determined by least squares linear regression. The D value is the time required, in seconds or minutes, for the population to decrease by 90% or 1-log when held at a certain temperature. Mathematically, it is the negative inverse of the slope of the regression line.

Results: The ohmic unit was operated at 120 volt. A stir bar was placed in the ohmic cell to ensure uniform temperature. The solution was stirred slowly during treatments. The ohmic unit was gently washed by soapy water and rinsed thoroughly with water between each run.

D-values: A summary of experimental D-values and coefficient of determination (r2) for each product is shown in Tables 2 thru 7. High coefficients of determination (r2) show a strong relationship between the log values and the pull times. The D-values for S. cerevisiae for the silver electrode trials were not calculated due to the instant die-off at 50° C. or higher. Test results showed that the silver electrode trials were more effective in reducing the number of the test microorganisms in the model product compared to the titanium electrode trials.

TABLE 2
Ohmic heating D values of L. monocytogenes

| | Titanium electrode at | Silver electrode |
|---|---|---|
| | 60° C. | at 55° C. |
| Trial 1 | 23.8 sec (r2 = 0.99) | 51.4 sec (r2 = 0.99) |
| Trial 2 | 19.3 sec (r2 = 0.99) | 36.7 sec (r2 = 0.99) |
| Trial 3 | 16.7 sec (r2 = 0.99) | 41.1 sec (r2 = 0.99) |
| Average | 19.9 sec | 43.1 sec |

TABLE 3
Ohmic heating D values of S. Senftenberg

| | Titanium electrode at | Silver electrode |
|---|---|---|
| | 60° C. | at 50° C. |
| Trial 1 | 13.6 sec (r2 = 0.97) | 16.4 sec (r2 = 0.99) |
| Trial 2 | 13.4 sec (r2 = 0.99) | 12.0 sec (r2 = 0.97) |
| Trial 3 | 13.4 sec (r2 = 0.99) | 13.1 sec (r2 = 0.99) |
| Average | 13.5 sec | 13.8 sec |

TABLE 4
Ohmic heating D values of S. cerevisiae

| | Titanium electrode at | Silver electrode |
|---|---|---|
| | 55° C. | at 50° C. |
| Trial 1 | 62.7 sec (r2 = 0.99) | Die off |
| Trial 2 | 46.4 sec (r2 = 0.96) | Die off |
| Trial 3 | 56.1 sec (r2 = 0.92) | Die off |
| Average | 55.1 sec | Die off |

TABLE 5
Ohmic heating D values of N. fischeri

| | Titanium electrode at | Silver electrode |
|---|---|---|
| | 82° C. | at 70° C. |
| Trial 1 | 15.6 min (r2 = 0.97) | 3.4 min (r2 = 0.81) |
| Trial 2 | 29.3 min (r2 = 0.87) | 3.5 min (r2 = 0.68) |
| Average | 22.5 min | 3.5 min |

TABLE 6
Ohmic heating D values of A. acidoterrestris

| | Titanium electrode at | Silver electrode |
|---|---|---|
| | 95° C. | at 93.5° C. |
| Trial 1 | 1.9 min (r2 = 0.90) | 2.1 min (r2 = 0.98) |
| Trial 2 | 1.6 min (r2 = 0.94) | 1.2 min (r2 = 0.97) |
| Trial 3 | 2.0 min (r2 = 0.97) | 1.6 min (r2 = 0.95) |
| Average | 1.8 min | 1.6 min |

TABLE 7
Ohmic heating D values of C. butyricum

| | Titanium electrode at | Silver electrode |
|---|---|---|
| | 85° C. | at 85° C. |
| Trial 1 | 5.1 min (r2 = 0.62) | 1.6 min (r2 = 0.96) |
| Trial 2 | 10.1 min (r2 = 0.90) | 1.8 min (r2 = 0.98) |
| Trial 3 | 3.7 min (r2 = 0..58) | 1.5 min (r2 = 0.93) |
| Average | 6.3 min | 1.6 min |

### Example 3

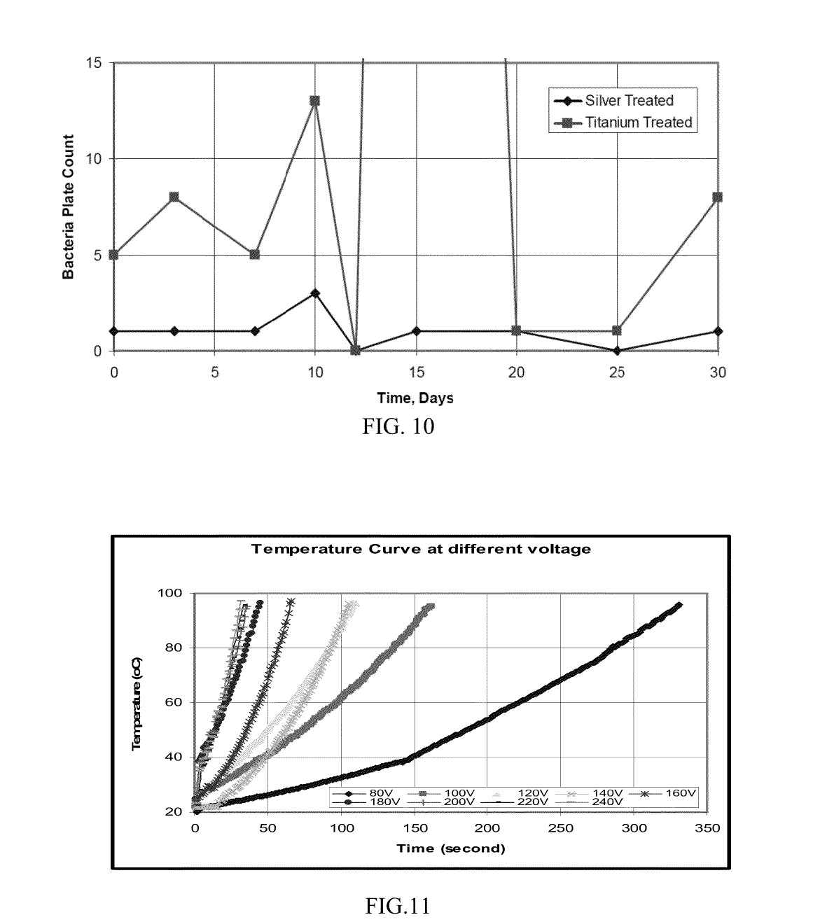

After treatment with silver electrodes up to 85° C. for 3 seconds, samples of orange juice were collected and analyzed for total bacterial count. In addition, samples obtained under the same conditions but using titanium electrode were collected and analyzed for total bacterial for comparison. Table 8 below summarizes the results. FIG. 10 represents a graphic presentation of the results.

TABLE 8

| | Bacteria | Bacteria |
|---|---|---|
| | burden per | burden per |
| Number | 1 ml Silver | 1 ml Titanium |
| of days | Treated | Treated |
| 0 | 1 | 5 |
| 3 | 1 | 8 |
| 7 | 1 | 5 |
| 10 | 3 | 13 |
| 12 | 0 | 0 |
| 15 | 1 | 130 |
| 20 | 1 | 1 |
| 25 | 0 | 1 |
| 30 | 1 | 8 |

The data shows that when silver was used, the total bacterial burden per 1 ml solution was always below 3 in contrast to when titanium was used, the total bacterial burden per 1 ml jumped to 130 after 15 days. This data indicates the preservative effectiveness of the silver in beverage.

### Example 4

Runs were performed by ohmic heating of the liquid water (pH=3.75, conductivity=3 mS/m) to 95° C. and then terminating the run.

FIG. 11 shows the temperature profiles obtained under different voltages using two silver electrodes. The voltage determined the rate of heating. FIG. 11 shows that as the voltage increased, the heating rate decreased.

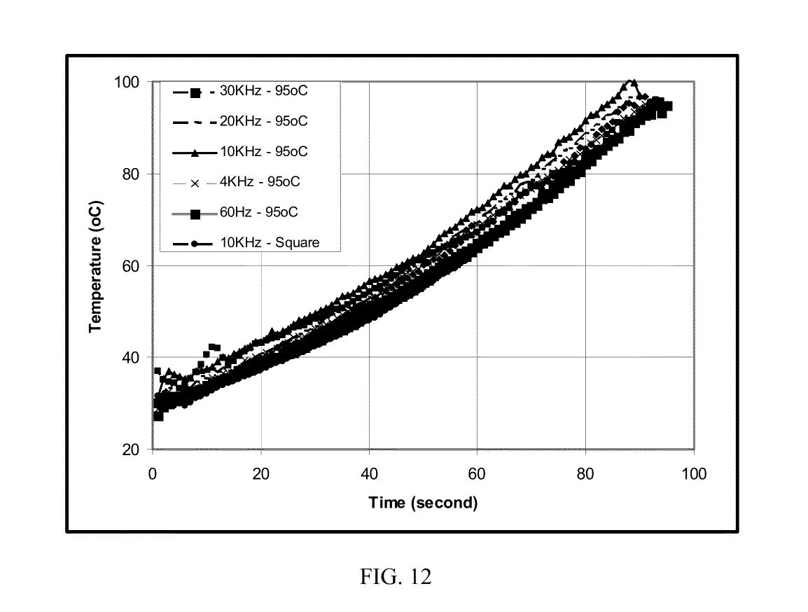

FIG. 12 shows the effect of different frequencies and frequency type on the heating rate using V=110v. FIG. 12 shows that there were no significant differences in the heating rate regardless of the shape or the frequency applied.

### Example 5

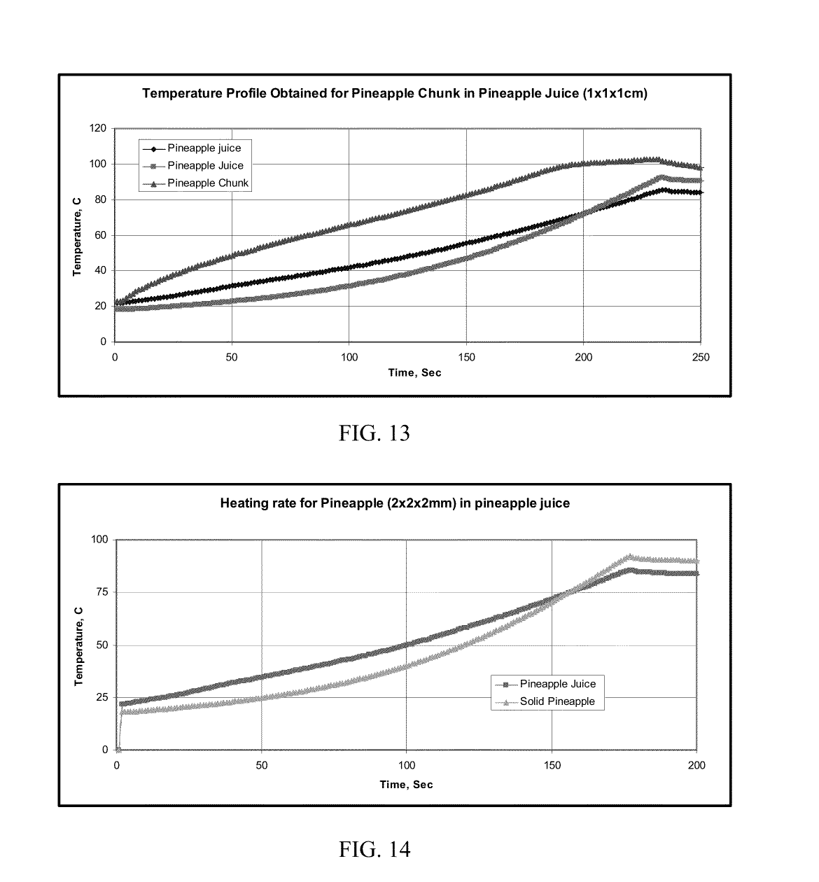

Experiments were conducted with pineapple chunks in pineapple juice using two silver electrodes. FIGS. 13 and 14 show the heating profile for different sized pineapple chunks in pineapple juice. In FIG. 13 the solid pineapple heated a little faster than the liquid pineapple juice. This may be due to water present in the juice.

### Example 6

These set of experiments were performed to study the effect of conductivity on silver electrode integrity. The experiments were conducted using the above described ohmic cell and water with a pH of 4. The conductivity was adjusted to the required value using sodium sulfate. Then 530 CC of the solution was placed in the Ohmic cell and heated to the required temperature. Once the desired temperature is reached, the run was terminated and samples were collected. The samples were labeled and send for analysis to a certified laboratory. The laboratory performed AOAC test Method 984.27 for silver concentration.

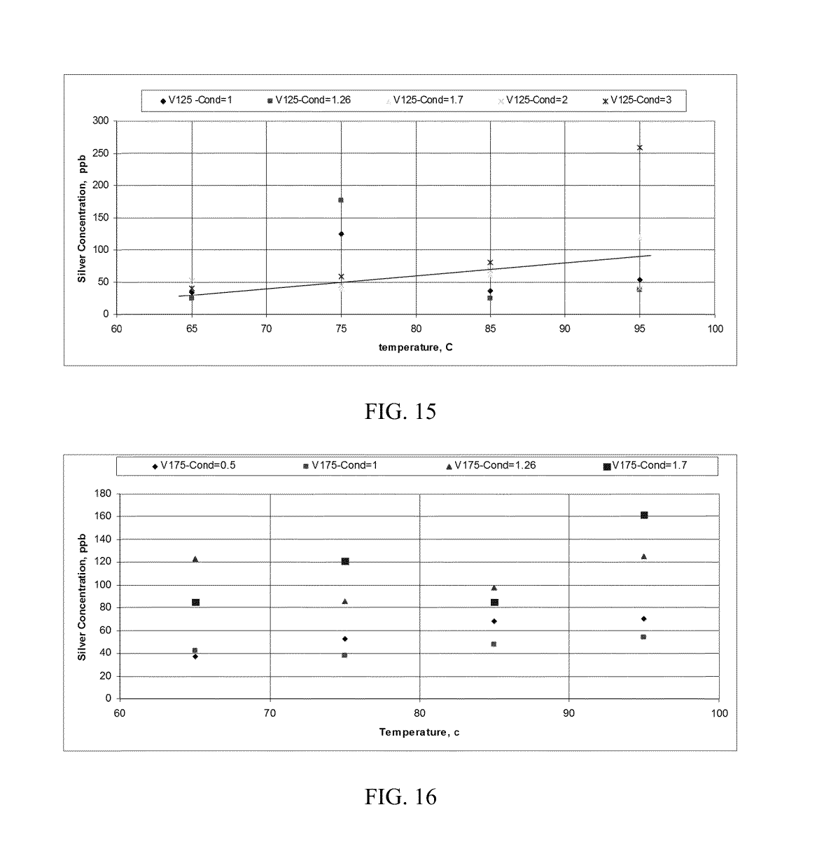

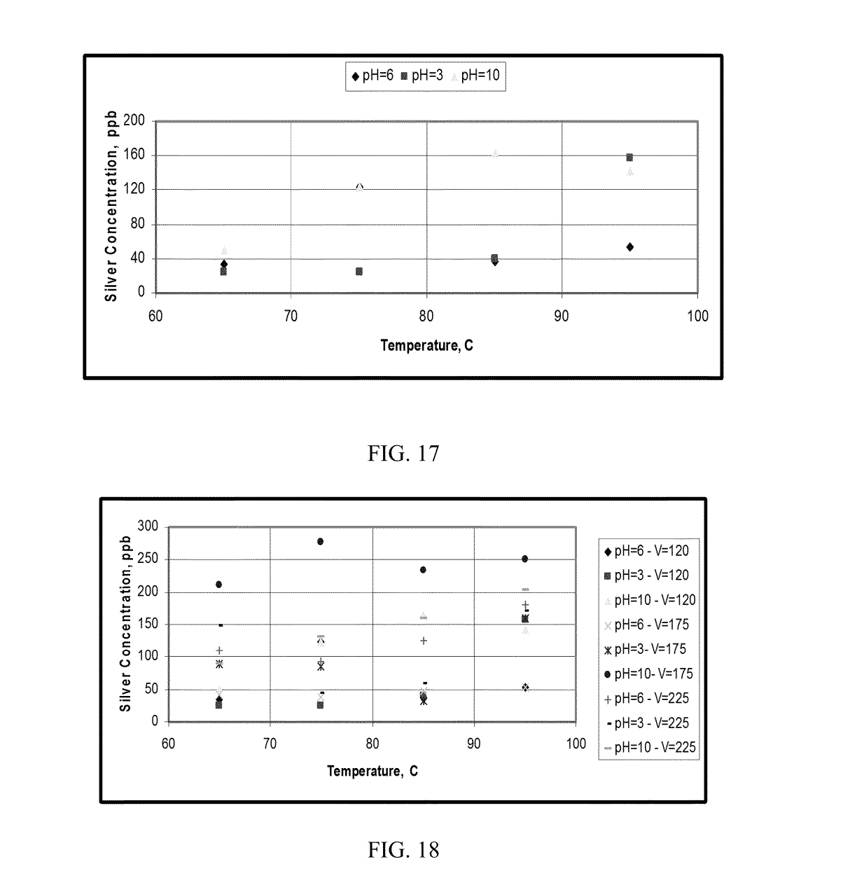

FIG. 15 gives summary of the results using 125V and FIG. 16 gives the same results obtained when 175V was applied. It is clear that regardless of the conductivity and or the voltage applied, the leaching of silver electrode showed stability and loss of electrode material was minimum and below 0.2 ppm which translates to extremely good electrode durability.

The next set of runs was performed to study the effect of pH, of the heated solution, on silver electrode stability. In the same manner mentioned above all runs were performed using water with a 1 mS/cm conductivity and different pHs. FIG. 17 gives a summary of the results. It is clear that the silver concentration was below 0.2 ppm at all times regardless of the pH. This translates to a very high corrosion resistance electrodes.

Finally, to examine the effect of voltage on the silver electrode stability these experiments were performed. The same procedure mentioned above was followed. The water solution pH was adjusted to 4 and the conductivity was kept at 1 mS/cm. The 530 cc of water was heated to the desired temperature. FIG. 18 summarizes the results. No silver concentration above 0.25 ppm was detected. Again one could conclude that durability of silver electrode is comparable to titanium.

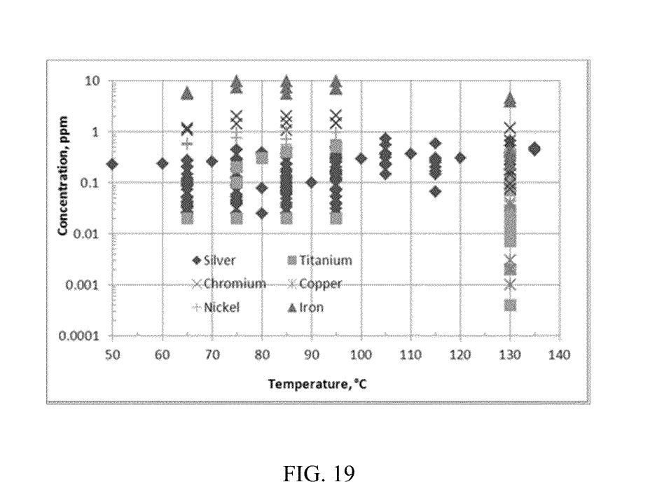

The same study was performed for the titanium electrode, sterling silver electrodes and stainless steel electrodes. FIG. 19 was constructed to compare leaching from the titanium electrode and the stainless steel electrodes with the leaching from the silver electrodes. In case of stainless steel electrodes, the samples were analyzed for chrome, nickel and iron. In case for the sterling silver electrodes samples were analyzed for copper in addition to silver. Table 9 below summarizes the method of analysis.

TABLE 9

| Mineral | Method reference |
|---|---|
| Silver | AOAC 984.27 |
| Titanium | EPA 3050/6020 USP730 |
| Chromium | EPA 3050/6020 USP730 |
| Nickel/copper | EPA 3050/6020 USP730 |
| Iron | EPA 3050/6020 USP730 |

FIG. 19 summarizes all the data obtained in this study regardless of the condition chosen. An average concentration for each (constituent) was calculated. The table 10 below summarizes the results.

TABLE 10

| Mineral | Average concentration, ppm |
|---|---|
| Silver | 0.18 |
| Titanium | 0.11 |
| Chromium | 1.10 |
| Copper | 0.014 |
| Iron | 5.29 |
| Nickel | 0.75 |

Based on the metal satiability leaching data presented in this section one can conclude that silver and titanium electrodes are superior to the stainless steel electrode, the most commonly used, with respect to durability.

### Example 7

Experiments were performed as follows: Two samples of 530 cc of beverage were heated up to 95C in a titanium electrode Ohmic cell. One sample was dosed with ionic silver ions while the other was kept with no silver ions. The silver ions were added at around 1 ppm to the treated liquids. The objective of this work is to find the effect of adding ionic silver and make comparison to the no silver (titanium heating) and the silver electrode heating. Both samples (with ionic and no ionic silver) were dosed with mold and/or yeast after the ohmic treatment. The samples were analyzed with respect to time for mold and yeast. It was determined that both silver and titanium were effective against yeast, but not against mold. It was observed that ionic silver added to the liquid will not kill molds but can kill bacteria. In order to kill molds, 10 ppm of ionic silver is needed which is too high for beverages suitable for consumption

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method of heating a liquid comprising heating the liquid with an ohmic heater comprising at least one silver electrode, silver alloy electrode, germanium electrode, or germanium alloy electrode.

2. The method of claim 1 comprising at least one silver or silver alloy electrode.

3. The method of claim 2 wherein the silver electrode or silver alloy electrode leaches silver ions in an amount of 1 ppm or less.

4. The method of claim 1 wherein the liquid is heated to at least 40° C.

5. The method of claim 1 wherein the liquid is heated to from ambient to 50° C. to 150° C.

6. The method of claim 1 wherein the liquid is a beverage selected from the group consisting of dairy beverages, juices, carbonated beverage syrup, and non-carbonated beverages.

7. The method of claim 5 wherein the amount of silver ions in the beverage is 0.5 ppm or less.

8. The method of claim 1 wherein the liquid is a pumpable fluid selected from the group consisting of soups, purees, high solid content fluids, pastes, syrups, and proteins.

9. The method of claim 1 wherein the liquid comprises particulates selected from the group consisting of vegetables, fruits, meats, gels, and grains.

10. The method of claim 9 wherein the average size of the particulates is between 0.5 mm and 2 cm.

11. The method of claim 1 wherein the ohmic heater comprises two silver electrodes or silver alloy electrodes.

12. The method of claim 1 wherein the ohmic heater comprises one silver electrode or silver alloy electrode and one other electrode.

13. The method of claim 12 wherein the other electrode is a titanium electrode.

14. A method of heating a liquid comprising heating the liquid with a Pulse Electric Field (PEF) heater comprising at least one silver electrode, silver alloy electrode, germanium electrode, or germanium alloy electrode.

15. The method of claim 14 comprising at least one silver or silver alloy electrode.

16. The method of claim 14 wherein the silver electrode or silver alloy electrode leaches silver ions in an amount of 1 ppm or less.

17. The method of claim 14 wherein the liquid is heated to at least 40° C.

18. The method of claim 17 wherein the liquid is heated to from ambient 50° C. to 65° C.

19. The method of claim 14 wherein the liquid is a beverage selected from the group consisting of dairy beverages, juices, carbonated beverage syrup, and non-carbonated beverages.

20. The method of claim 14 wherein the amount of silver ions in the beverage is 0.5 ppm or less.

21. The method of claim 14 wherein the liquid is a pumpable fluid selected from the group consisting of soups, purees, high solid content fluids, pastes, syrups, and proteins.

22. The method of claim 14 wherein the liquid comprises particulates selected from the group consisting of vegetables, fruits, meats, gels, and grains.

23. The method of claim 22 wherein the average size of the particulates is between 0.5 mm and 2 cm.

24. The method of claim 14 wherein the PEF heater comprises two silver electrodes or two silver alloy electrodes.

25. The method of claim 14 wherein the PEF heater comprises one silver electrode or silver alloy electrode and one other electrode.

26. The method of claim 25 wherein the other electrode is a titanium electrode.
